(19) United States
(12) Patent Application Publication
(10) Pub. No.: US 2003/0019323 A1
(43) Pub. Date: Jan. 30, 2003

(54) Mechanical linkage assembly

(75) Inventors: Brian George Babin, Goshen, IN (US); Todd Anthony Brown, Elkhart, IN (US); Ronald Jay Wolf, Elkhart, IN (US)

Correspondence Address: Patent Administrator, Suite 1600, 525 West Monroe Street, Chicago, IL, 60661-3693, US

(73) Assignee: American Electronic Components

(21) Appl. No.: 09/912,359

(22) Filed: Jul. 25, 2001

Related U.S. Application Data
(63) Continuation-in-part of application No. 09/653,507, filed on Sep. 1, 2000.

(51) Int. Cl. G05G 1/00

(52) U.S. Cl. 74/579 R

(57) ABSTRACT

A mechanical linkage assembly, which includes one or more mechanical devices, such as ball joint assemblies, over molded around one or both opposing ends of a connecting rod. The connecting rod is formed with a reduced diameter portion to enable the mechanical device to rotate relative thereto, while limiting axial movement therebetween. In such a configuration, the same tooling can be used even though the length of the connecting rod changes, since the mechanical devices can be molded one after the other on the ends of the connecting rod which reduces the cost and complexity of manufacturing the assembly.

### CROSS REFERENCE TO RELATED APPLICATIONS

This application is a continuation-in-part of co-pending U.S. patent application Ser. No. 09/653,507 filed on Sep. 1, 2000.

### BACKGROUND OF THE INVENTION

1. Field of the Invention

The present invention relates to a mechanical linkage assembly and more particularly to a mechanical linkage assembly which includes one or more mechanical devices, such as ball joint assemblies, molded on one or both ends of a connecting rod and configured such that the mechanical devices are rotatable with respect to the connecting rod which enables assemblies with difference length connecting rods to be molded utilizing a single set of tooling.

2. Description of the Prior Art

Various mechanical linkage assemblies are known in the art which include at least one ball joint assembly rotatably connected to a connecting rod. Examples of these mechanical linkage assemblies are disclosed in U.S. Pat. Nos. 5,795,092; 6,161,451; 1,814,999; 1,886,143; 5,765,844; 6,119,550 and 6,164,860. However, such mechanical linkage assemblies are relatively complicated and expensive to manufacture. For example, U.S. Pat. No. 6,164,860 discloses a pair of ball joint assemblies coupled together by a pair of connecting rods. One of the connecting rods is formed with an angular recess adjacent one end that is adapted to cooperate with an annular protrusion on the other connecting rod to couple the two connecting rods together. A ball joint assembly is formed on the free end of each of the connecting rods. An elastic member is used within the coupling of the two connecting rods to absorb vibration. Unfortunately, such a configuration is relatively expensive to manufacture. In particular, the configuration requires separate connecting rods with a ball joint assembly rigidly attached to each of the connecting rods. Such a configuration would also be susceptible to shear loading at the coupling joint of the two connection rods.

Other U.S. Patents are known which disclose ball joint assemblies are configured to be screwed onto the connecting rod and are thus rotatable. Examples of such configurations are disclosed on U.S. Pat. Nos. 5,795,092; 1,814,999; 1,886,143 and 6,119,550. Although these assemblies are rotatable, they are configured to be clamped to prevent rotation after assembly and are thus not suitable for many applications.

Finally, U.S. Pat. No. 6,161,451 discloses a mechanical linkage assembly which includes a pair of ball joint assemblies disposed on opposing ends of a connecting rod. The connecting rod is formed with a generally square extending head on each end and is adapted to be received in a square aperture in each of the ball joint assemblies. The configuration of the square head and square aperture enable the ball joint assemblies to be configured such that the axial positions of the ball joint assemblies can be continuously positioned in any of one of various detent positions relative to one another. However, such a configuration is not suitable for an application in which the ball joint assemblies need to be rotatable with respect to the connecting rod after assembly.

Although the above mentioned assemblies allow rotation of the ball joint assemblies, the disclosed configurations are relatively complex and expensive to manufacture. Moreover, the configurations disclosed in the prior art require different tooling when design parameters such as the length of the connecting rod changes. Thus, there is a need for a mechanical linkage assembly, which is relatively simple to manufacture and enables the same tooling to be used when the length of the connecting rod changes.

### SUMMARY OF THE INVENTION

Briefly, the present invention relates to a mechanical linkage assembly, which includes one or more mechanical devices, such as ball joint assemblies, molded around one or both opposing ends of a connecting rod. The connecting rod is formed with a reduced diameter portion adjacent one or both ends for rotatably receiving one or more mechanical devices and limiting axial movement therebetween. In such a configuration, the same tooling can be used even though the length of the connecting rod changes, since the mechanical devices can be molded one after the other on the ends of the connecting rod which reduces the cost and complexity of manufacturing the assembly.

### DESCRIPTION OF THE DRAWINGS

These and other advantages of the present invention will be readily understood with reference to the following specification and attached drawing wherein;

FIG. 1 is a prospective view of the mechanical linkage assembly in accordance with the present invention.

FIG. 2 is a prospective view of an application of the mechanical linkage assembly in accordance with the present invention.

FIG. 3 is a plan view of the mechanical linkage assembly illustrated in FIG. 1.

FIG. 4 is a sectional view along line 4-4 of FIG. 3.

FIG. 5 is a sectional view along line 5-5 of FIG. 3.

FIG. 6 is a plan view of a connecting rod in accordance with the present invention.

### DESCRIPTION OF THE PRIOR ART

The present invention relates to a mechanical linkage assembly, which includes a connecting rod with one or more mechanical devices, such as ball joint assemblies, rotatably disposed on one or both ends. An important aspect of the invention is that the configuration of the connecting rod and mechanical devices allows each mechanical device to be separately over molded on the connecting rod which enables the same tooling to be used for different lengths of connecting rods.

Another important aspect of the invention is that the mechanical linkage assembly is adapted to be used in a variety of applications for connecting two members that are not aligned in a radial direction. In such an application, the mechanical devices may simply be rotated by hand to compensate for the lack of radial alignment.

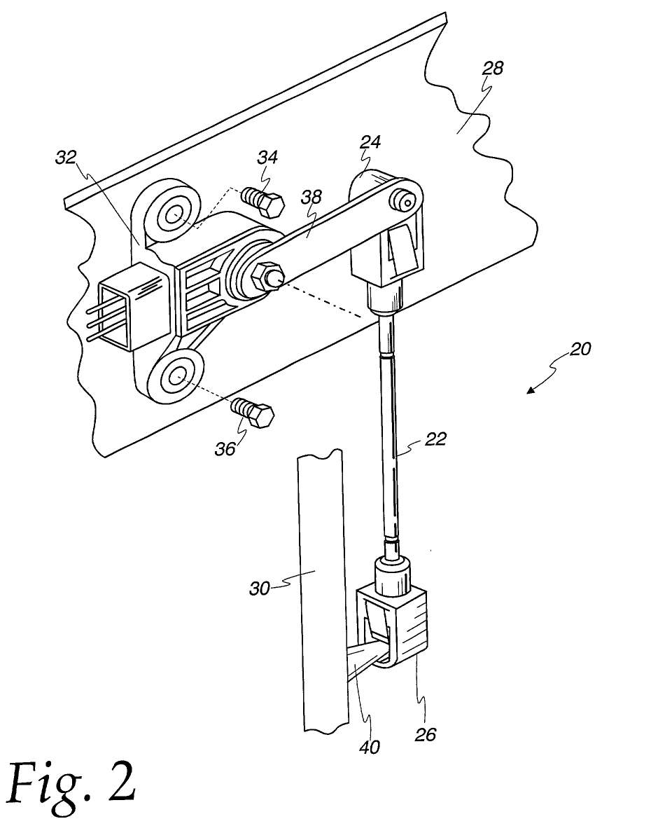

An exemplary application of the mechanical linkage assembly 20 is illustrated in FIG. 2. In this application, the mechanical linkage assembly 20 is utilized in an automotive application in combination with a sensor for measuring the displacement of a vehicle chassis 28 relative to a vehicle suspension 30. As shown in FIG. 2, a rotary position sensor 32, for example, as disclosed in co-pending U.S. application Ser. No. 09/653,507, filed on Sep. 1, 2001 and copending patent applications filed on even date (attorney docket nos. 5915 and 5917 AEC), all hereby incorporated by reference, is secured to the vehicle chassis 28 with a pair of fasteners 34 and 36. A mounting bracket may be used to secure position sensor 32 to chassis 28. A lever arm 38 is connected on one end to the rotary position sensor 32. The other end of the lever arm 38 is provided with an extending ball stud formed as a post with a ball on one end (not shown). The ball is received in the ball joint assembly 24 to rotatably couple the ball joint assembly 24 with the lever arm 38.

An extending ball stud 40 is rigidly connected to the chassis 30. The ball stud 40 is received in the ball joint assembly 26 to provide a rotatable coupling between the vehicle chassis 30 and the ball joint assembly 26.

As shown, any differences in the height of the vehicle chassis 28 relative to the vehicle suspension 30 will cause the lever arm 38 to rotate either upwardly or downwardly. This rotation is sensed by the rotary position sensor 32 to provide indication of the position of the vehicle chassis 28 relative to the vehicle suspension 30.

As shown, the ball studs 40 attached to the lever arm 38 and suspension 30, are for example 90° apart in this application, depending on the amount of play in the lever arm 38. Since the ball joint assemblies 24 and 26 are rotatable with respect to the connecting rod 22, the mechanical linkage 20 can be fabricated without regard to the relative radial positions of the ball studs connected to the vehicle chassis 28 and the suspension 30.

The mechanical linkage assembly 20 is described and illustrated with a connecting rod and an exemplary ball joint assembly rotably connected on each end. The principles of the present invention; however, are clearly applicable to other mechanical devices, other than ball joint assemblies. Moreover, the principles of the present invention are applicable to a mechanical linkage assembly in which mechanical devices are formed on both ends or just on one end.

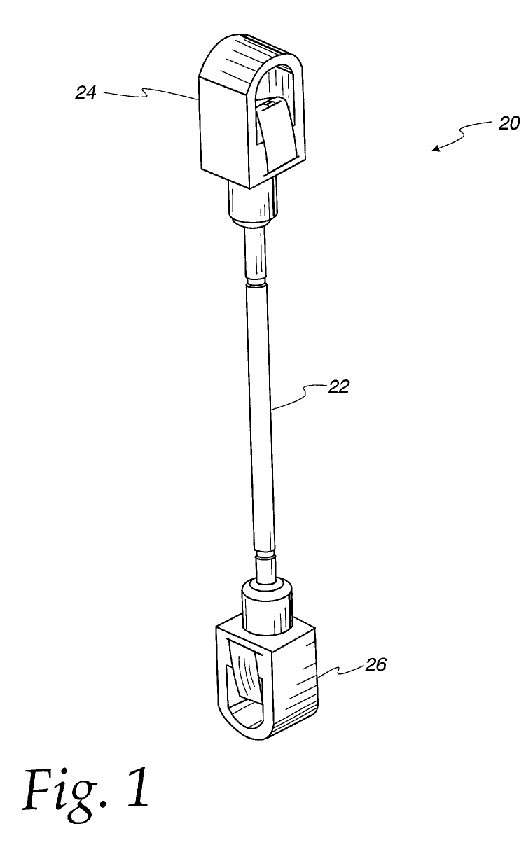

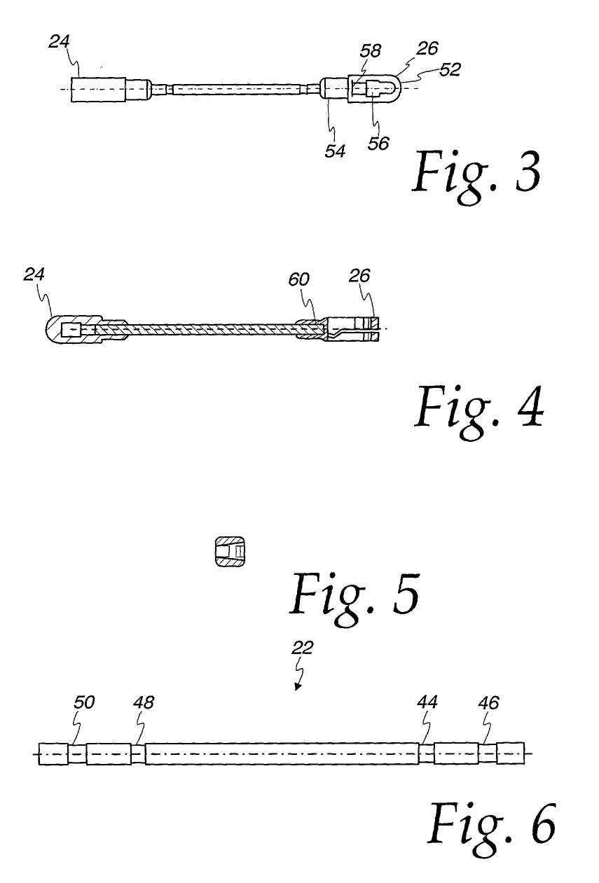

Referring to FIG. 1, the mechanical linkage, generally identified with the reference numeral 20, includes a connecting rod 22 and one or more mechanical devices, for example, ball joint assemblies 24 and 26, disposed on one or both ends. As shown in FIGS. 3-6, the connecting rod 22 may be formed as an elogated rod from a rigid metal or plastic material, which will not bond or interact with the material used for the ball joint assemblies 24 and 26, for example SAE 1215 steel, with or without plating. An exemplary plating is black zinc/iron plate.

As shown, the connecting rod 22 may be provided with two undercuts 44, 46 and 48, 50 on each end. The outer most undercuts 46 and 50 are adapted to receive an interior annular ring as discussed below, formed in the ball joint assemblies 24 and 26, to enable the ball joint assemblies 24 and 26 to rotate relative to the connecting rod 22 while restraining axial movement. The innermost undercuts 44 and 48 or equivalent structure may be used as an index for positioning the connecting rod 22 within a mold (not shown).

As shown, the ball joint assemblies 24 and 26 are molded on each end of the connecting rod 22. In order to reduce the tooling cost, one end of the connecting rod 22 can be molded at a time, thus reducing the tooling cost and enabling the same tooling to be used for difference length connecting rods 22. More particularly, the ball joint assemblies 24 and 26 are over molded around the ends of the connecting rod 22. As mentioned above, the undercuts 44 and 48 or equivalent structure may be used to locate the connecting rod 22 within the mold for the ball joint assemblies 24 and 26.

An exemplary configuration of the ball joint assemblies is illustrated in FIGS. 1-5. Other configurations are considered to be within the broad scope of the invention, including unitary ball joints and other mechanical devices. The only critical aspect is that the mechanical device or ball joint assembly be formed with a sleeve with an interior annular ring that is adapted to cooperate with the undercuts 46 and 50 to allow the ball joint assemblies 24 and 26 or other mechanical devices to rotate relative to the connecting rod 22, while at the same time restraining axial movement.

The ball joint assemblies 24 and 26 or other mechanical devices may be formed from any plastic material, such as RPT 4005 TFE 15 (Polyphthalamide (PA), 30%, glass filled (GF), Polyterafluorethylene (PTFE) lubricated).

As shown in FIG. 3, each exemplary ball joint assembly 24, 26 includes a ball socket portion 52 and a sleeve portion 54. In the exemplary configuration, illustrated in FIGS. 1-5, the ball socket portion 52 is formed with an elongated axial slot 56 and a transverse slot 58. The transverse slot 58 is as adapted to receive a generally C shape spring (not shown) for biasing a ball stud 40 within the ball socket 52. Other configurations of the ball socket 52 are also suitable including unitary configurations in which the ball socket and is formed as a single unitary member.

As mentioned above, each ball joint assembly 24 and 26 or other mechanical device is formed with a sleeve portion 24. The respective sleeve portions 24 are formed with an interior annular ring 60, adapted to be received in the recesses 46 and 50. The ring 60 in cooperation with the recesses 46 and 50 allow the ball joint assemblies 24 and 26 or other mechanical devices to rotate relative to the connecting rod 22 while restraining axial movement therebetween.

Obviously, many modifications and variations of the present invention are possible in light of the above teachings. Thus, it is to be understood that, within the scope of the appended claims, the invention may be practiced otherwise than as specifically described above.

What is claimed and desired to be covered by a Letter Patent is as follows:

We claim:

1. A mechanical linkage assembly comprising:
an elongated connecting rod defining two ends, said connecting rod formed with a reduced diameter portion adjacent at least one end; and
at least one mechanical device formed with an extending sleeve portion, said sleeve portion formed with an internal annular ring adapted to be received in said reduced diameter portion of said connecting rod to enable said mechanical device to rotate relative to said connecting rod while limiting axial movement therebetween.

2. The mechanical linkage assembly as recited in claim 1, wherein at least one of said mechanical devices is a ball joint assembly.

3. The mechanical linkage assembly as recited in claim 2, wherein said at least one ball joint assembly is molded on one end of said connecting rod.

4. The mechanical linkage assembly as recited in claim 1, wherein said connecting rod is formed from steel.

5. The mechanical linkage assembly as recited in claim 1, wherein said connecting rod is formed from a plastic material.

6. The mechanical linkage assembly as recited in claim 3, wherein said connecting rod includes at least one index for positioning said connecting rod within a mold.

7. The mechanical linkage assembly as recited in claim 1, wherein mechanical devices are formed on opposing ends of said connecting rod.

8. The mechanical linkage assembly as recited in claim 7, wherein said mechanical devices are molded on the ends of said connecting rod.

9. The mechanical linkage assembly as recited in claim 8, wherein at least one or said mechanical devices is a ball joint assembly.

10. The mechanical linkage assembly as recited in claim 8, wherein both of said mechanical linkage assemblies are ball joint assemblies.

11. A process for forming a mechanical linkage assembly comprising the steps of:
(a) providing an elongated connecting rod, defining opposing ends with a reduced diameter portion adjacent at least one end;
(b) providing an injection mold configured to form a mechanical device with an extending sleeve said sleeve having an interior annular ring;
(c) disposing one end of said connecting rod on an injection mold; and
(d) overmolding said mechanical device around at least one end of said connecting rod to form an intermediate assembly.

12. The process as recited in claim 11, wherein said connecting rod is provided with reduced diameter portions on each end.

13. The process as recited in claim 12, further including the steps;
(a) removing said intermediate assembly from said injection mold;
(b) disposing said opposing end of said connecting rods in said injection mold; and
(c) injection molding said mechanical device with said extending sleeve around said opposing end of said connecting rod to form a final assembly.
